(19) United States
(12) Patent Application Publication
(10) Pub. No.: US 2023/0236867 A1
(43) Pub. Date: Jul. 27, 2023

(54) INFORMATION PROCESSING DEVICE, METHOD AND RECORDING MEDIUM STORING COMPUTER PROGRAM

(71) Applicant: LATONA, INC., Tokyo (JP)

(72) Inventors: Satoshi TAKAHASHI, Tokyo (JP); Sho ISHII, Tokyo (JP); Kyoko OTAWA, Tokyo (JP)

(73) Assignee: LATONA, INC., Tokyo (JP)

(21) Appl. No.: 18/041,988

(22) PCT Filed: Aug. 16, 2021
(86) PCT No.: PCT/JP2021/029856

§ 371 Date: Feb. 16, 2023

(30) Foreign Application Priority Data
Aug. 17, 2020 (JP) 2020-137631

(51) Int. Cl. G06F 9/455; H04L 41/0853

(52) U.S. Cl. CPC G06F 9/45558; H04L 41/0856; G06F 2009/45595

(57) ABSTRACT

An information processing device is an information processing device serving as a member device that constitutes a network system, including: a detection unit that performs autonomous inquiry to the connected network system and detects another member device that together forms the network system; and a list management unit that, when the another member device is detected by the detection unit, updates a list indicating member devices of the network system that are newly registered in the network system via the another member device.

### TECHNICAL FIELD

The present invention relates to an information processing device, a method for controlling the information processing device, a computer program used for controlling the information processing device, and a recording medium of the computer program.

### BACKGROUND ART

In a network system implemented by a plurality of member devices, it is generally necessary to provide a server for managing the network system. Therefore, when another device is additionally registered as a member device in the network system, the server needs to register that device in the network system as a new member device.

For example, according to a technique disclosed in JP2007-265045A, equipment that constitutes a network system stores an object identifier according to an object that performs specific processing, and a server manages the network system based on the object identifier. As a result, the system can be constructed without depending on network connection setting, so that it is possible to flexibly cope with the increase or decrease of the equipment.

### SUMMARY OF INVENTION

According to the technique disclosed in JP2007-265045A, it is necessary to use the server to manage the network system. Providing such a server for managing the network system may increase the number of man-hours for system design.

The present invention is made to solve the above-mentioned problem, and an object of the present invention is to provide a network system which does not require a host computer or the like and requires less man-hours for designing, and the like.

The above-mentioned problem can be solved by an information processing device having the following configuration and the like.

That is, an information processing device according to an aspect of the present invention is an information processing device serving as a member device that constitutes a network system, including: a detection unit that performs autonomous inquiry to the connected network system and detects another member device that together forms the network system; and a list management unit that, when the another member device is detected by the detection unit, updates a list indicating member devices of the network system that are newly registered in the network system via the another member device.

According to this aspect of the present invention, after the information processing device is connected to the network system, a member device that forms the network system is specified by autonomous inquiry, and the information processing device shares a member device list of the network system with the member device, and registered as a new member device. Therefore, a host for managing the network system becomes unnecessary, and the network system can be constructed with a small number of designing man-hours without considering master-slave relations, connection orders, and the like among devices.

### BRIEF DESCRIPTION OF DRAWINGS

FIG. 1 is a block diagram of a data processing system including a data processing device according to a first embodiment.

FIG. 2 is a hardware configuration diagram of the data processing device.

FIG. 3 is a software configuration diagram of a first device.

FIG. 4 is a software configuration diagram of an additional device.

FIG. 5 is a flowchart showing registration control in the additional device during participation of the additional device.

FIG. 6 is a flowchart showing registration control in the additional device.

FIG. 7 is a sequence chart showing mutual processing of registration control between the additional device and the first device.

FIG. 8 is a diagram showing an example of a group database.

FIG. 9 is a sequence chart showing initial setting control of the additional device.

FIG. 10 is a diagram showing an example of a group database according to a second embodiment.

FIG. 11 is a flowchart showing redeployment request control of an abnormal pod by a first device according a third embodiment.

FIG. 12 is a flowchart showing redeployment control in a second device.

FIG. 13 is a sequence chart showing mutual processing of redeployment control between the first device and the second device.

### DESCRIPTION OF EMBODIMENTS

Hereinafter, embodiments of the present invention will be described with reference to the drawings.

### First Embodiment

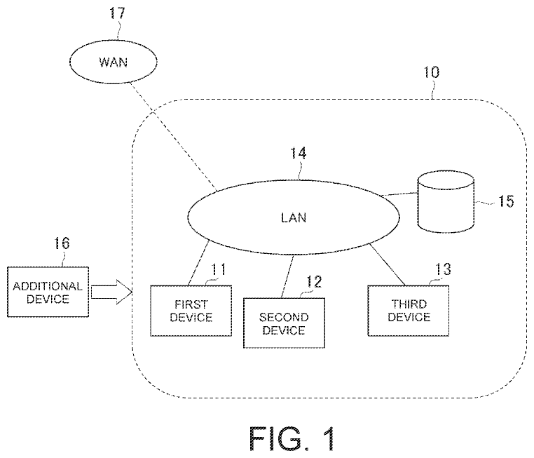

FIG. 1 is a block diagram showing a configuration of a data processing system including a data processing device according to the present embodiment.

A data processing system 10 is, for example, a system that monitors each step of a manufacturing process, a construction process, and the like, and controls work equipment used in each step in a local environment such as a factory or a construction site. The data processing system 10 includes a first device 11, a second device 12, and a third device 13, which are connected to each other via a LAN 14. The data processing system 10 includes a storage 15 capable of storing data.

The first device 11, the second device 12, and the third device 13 perform predetermined processing in the local environment. As an example, these devices acquire sensor information detected by sensors, that is, images and moving images captured by cameras, angle information detected by angle sensors, and the like. In the data processing system 10, the first device 11 to the third device 13 cooperate with each other to perform processing.

Hardware of the first device 11, the second device 12, and the third device 13 is provided by the same vendor. Therefore, for example, MAC addresses used for Ethernet connection via the LAN 14 are values within a predetermined range assigned by the vendor.

The storage 15 stores not only data acquired by the first device 11, the second device 12, and the third device 13, but also image data of operation programs of the first device 11 to the third device 13 that constitute the data processing system 10. The storage 15 may also store log data and program data.

The data processing system 10 may be configured to communicate with a WAN 17. When connected to the WAN 17, the data processing system 10 may operate using resources on the WAN 17.

In the present embodiment, an additional device 16 is newly registered in such a data processing system 10. This additional device 16 is provided by the same vendor as the first device 11, second device 12, and third device 13, and has a MAC address within a predetermined range.

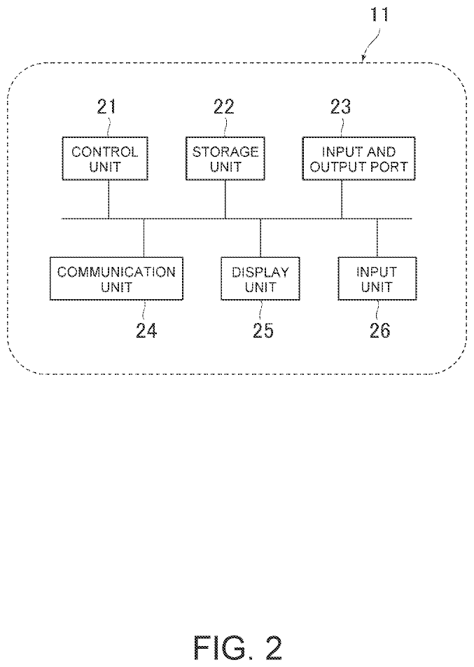

FIG. 2 is a diagram showing an example of hardware configuration of the first device 11. Note that the second device 12, the third device 13, and the additional device 16 have the hardware configuration shown in this drawing.

The first device 11 includes a control unit 21 that is implemented by a central processing unit (CPU) controlling the whole system and a graphics processing unit (GPU), a storage unit 22 that is implemented by a read only memory (ROM), a random access memory (RAM), a hard disk, or the like, and stores programs, various data, and the like, an input and output port 23 that inputs and outputs data to and from an external device, a communication unit 24 that performs communication via the LAN 14, a display unit 25 that is implemented by a display, an LED, a speaker, or the like and performs display according to the data, and an input unit 26 that receives input from outside such as a keyboard. The control unit 21, the storage unit 22, the input and output port 23, the communication unit 24, the display unit 25, and the input unit 26 are configured to be able to communicate with each other by bus connection.

A program is stored in the storage unit 22, and the first device 11 is configured to perform predetermined processing on input data by the stored program performing a predetermined operation. The first device 11 is configured to be able to communicate with the second device 12, the third device 13, and the storage 15 via the wired and wireless LANs 14 by the communication unit 24.

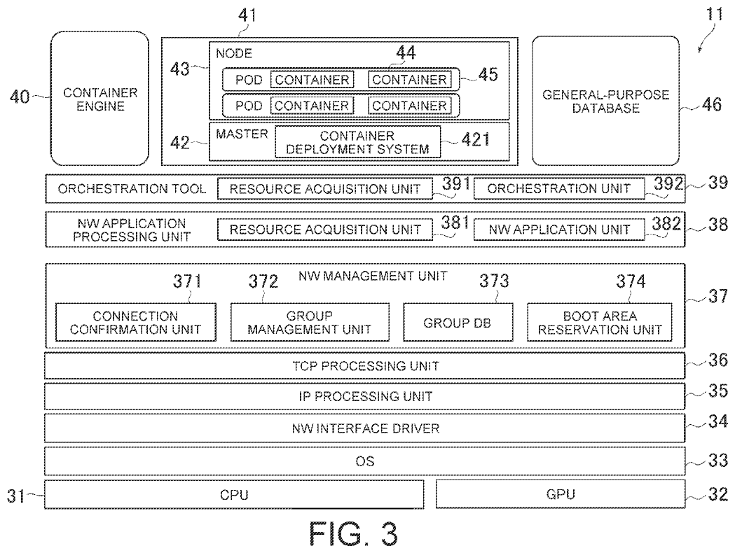

FIG. 3 is a software configuration diagram of the first device 11. Note that the second device 12 and the third device 13, which operate as members of the data processing system 10 like the first device 11, have the same software configuration.

An outline of this software configuration is as follows.

An operation system (OS) 33 is provided on a CPU 31 and a GPU 32, and a network (NW) interface driver 34, an IP processing unit 35, and a TCP processing unit 36 for implementing a communication function are provided thereon. A network (NW) management unit 37 used for registration and management of the data processing system 10 is provided.

Furthermore, a network (NW) application processing unit 38 is provided so that a higher-level application can use the communication functions provided by the NW interface driver 34, IP processing unit 35, and TCP processing unit 36. The application implements a communication function using an interface provided by this NW application processing unit 38.

An orchestration tool 39 and a container engine 40 are provided in an application layer in a level higher than the NW application processing unit 38. An operating application is containerized by the container engine 40, and hardware resource necessary for the operation are managed (orchestrated) by the orchestration tool 39.

When the orchestration tool 39 is provided, an orchestration processing area 41 that is an operating environment for the application is configured, and the application operates within the orchestration processing area 41. A general-purpose database 46 is provided in a non-containerized area. Note that the orchestration processing area 41 may be referred to as a cluster.

Hereinafter, details of these software configurations will be described in order.

The OS 33 that operates on the hardware implemented by the CPU 31 and the GPU 32 is installed. The OS 33 is the most basic software for managing the entire system and running various kinds of application software. Furthermore, on the OS 33, the NW interface driver 34 related to a network connection function is provided. On the NW interface driver 34, the IP processing unit 35 and the TCP processing unit 36 are provided to provide a communication function according to a predetermined protocol.

The NW interface driver 34 implements a communication function using the Ethernet, MAC addresses, and the like, which correspond to a physical layer (L1) and a data link layer (L2) in an OSI reference model. The IP processing unit 35 implements communication using an IP protocol corresponding to a network layer (L3), and the TCP processing unit 36 implements communication using a TCP protocol corresponding to a transport layer (L4).

The NW management unit 37 and the NW application processing unit 38 are provided as functional blocks that perform protocol processing in a level higher than the TCP processing unit 36.

The NW management unit 37 is a block that performs group management of the data processing system 10 that operates together with the second device 12 and the third device 13, and includes a connection confirmation unit 371, a group management unit 372, a group database 373, and a boot area reservation processing unit 374. The NW management unit 37 communicates with other devices mainly using the communication function provided by the IP processing unit 35, that is, the communication function in the network layer of the OSI reference model (the Internet layer in a TCP/IP layer model).

The connection confirmation unit 371 mainly performs registration processing to the data processing system 10 autonomously when its own device is newly connected to the data processing system 10. The group management unit 372 manages group member devices (the first device 11 to the third device 13 and the additional device 16) of the data processing system 10.

The group database 373 is a database (list) indicating management information by the group management unit 372, is arranged in a cache memory, and can be accessed at a high speed. The group database 373 mainly records information required for the communication function by the network layer provided by the IP processing unit 35. The group database 373 uses, for example, a distributed storage type database system such as etcd, and is synchronized among the devices (the first device 11 to the third device 13 and the additional device 16) that constitute the data processing system 10 by communicating using a predetermined diffusion protocol (gossip overlay protocol or the like). The boot area reservation processing unit 374 is used for software construction during initial setting when its own device is newly registered in the data processing system 10.

Furthermore, in the first device 11, the NW application processing unit 38 is provided. The NW application processing unit 38 performs application control using the communication functions of the NW interface driver 34 to the TCP processing unit 36, separately from the management of the data processing system 10 by the NW management unit 37.

The NW application processing unit 38 includes a resource acquisition unit 381 and a NW application unit 382. During the initial setting, first, the resource acquisition unit 381 is downloaded and configured in the first device 11. Thereafter, the resource acquisition unit 381 downloads the NW application unit 382 to the first device 11, thereby acquiring operation resource of the NW application processing unit 38. In this way, the function of the NW application processing unit 38 can be implemented.

The orchestration tool 39 includes a resource acquisition unit 391 and an orchestration unit 392. During the initial setting, first, the resource acquisition unit 391 is downloaded and configured in the first device 11. Thereafter, the resource acquisition unit 391 downloads the orchestration unit 392 to the first device 11, thereby acquiring operation resource of the orchestration tool 39. In this way, an orchestration environment can be constructed by the orchestration tool 39.

Then, a container engine 40 is provided in the environment configured by the orchestration tool 39. Note that the container engine 40 can form a container area by virtualizing hardware resource and the like, and can operate an application in the container environment. As a result, the containerized application is executed in the container environment formed by the container engine 40 with the hardware resource managed by the orchestration tool 39.

The application that is containerized in this way is integrally configured with a library and is sometimes referred to as containerization. In this way, the container environment configured by the container engine 40 is resource-managed by the orchestration tool 39, and the containerized applications operate in such an environment.

Specifically, the orchestration tool 39 constructs a logical area referred to as the orchestration processing area 41 as an environment in which the containerized application is executed. The orchestration processing area 41 is provided with a master 42 that manages the entire orchestration processing area 41 and a node 43 that is an execution environment for the application. The master 42 manages hardware resource of the node 43, which is an execution environment of a container 44.

The node 43 is provided with the container 44 in which an application is integrated with a library, and one or more containers 44 (two containers 44 in FIG. 3) are managed in a unit called a pod 45. Note that the pod 45 may include one or more containers 44. The pod 45 is managed by a pod management block within the node 43. Note that the pod management block performs resource management in the node 43 according to an instruction from the master 42.

The master 42 includes a container deployment system 421, and the container deployment system 421 deploys the pod 45 in the node 43 during the initial setting. In this way, an environment in which the application (pod 45) can be executed is formed.

Thus, in an environment in which the orchestration tool 39 and the container engine 40 are introduced, containerized applications are managed in a unit of the pod 45. Then, the pod 45 is executed in the node 43 within the orchestration processing area 41. Note that non-containerized applications (not shown in FIG. 3) may be operated without using the resource of the orchestration processing area 41. Such non-containerized applications can communicate bi-directionally with the pod 45 within the orchestration processing area 41.

Note that the first device 11 is provided with the general-purpose database 46 outside the orchestration processing area 41. The pod 45 can access the general-purpose database 46 and read and write data when executing predetermined processing.

In the present embodiment, an example in which one node 43 is provided in the orchestration processing area 41 is described, but the present invention is not limited thereto. A plurality of the nodes 43 may be provided within the orchestration processing area 41.

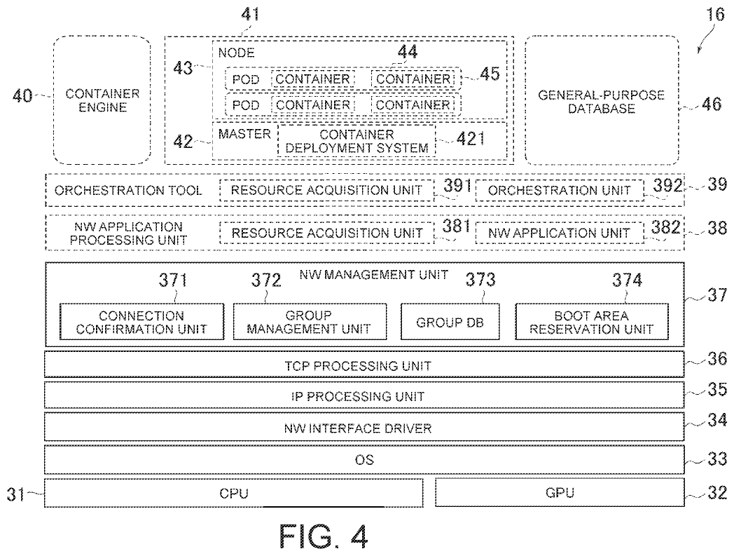

FIG. 4 is a software configuration diagram of the additional device 16.

Here, when comparing the configuration of the first device 11 in FIG. 3 and a configuration of the additional device 16 in FIG. 4, the configurations of the CPU 31 to the NW management unit 37 are provided in common. However, the configurations of the NW application processing unit 38 to the general-purpose database 46 existing in the first device 11 are indicated by dotted lines in FIG. 4. It means that these configurations are not present in the additional device 16 during the initial setting.

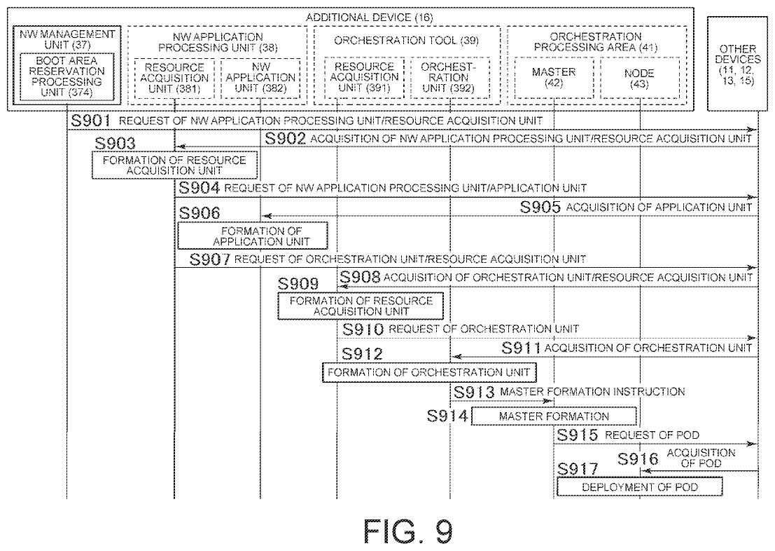

The additional device 16 includes at least the configurations of the CPU 31 to the NW management unit 37 when the additional device 16 is newly registered for participation in the data processing system 10. After the additional device 16 is registered in the data processing system 10 by the NW management unit 37, the configurations of the NW application processing unit 38 to the general-purpose database 46 are downloaded from the other devices of the data processing system 10. Such initial setting control will be described later with reference to FIG. 9. Registration control of the additional device 16 to the data processing system 10 will be described below.

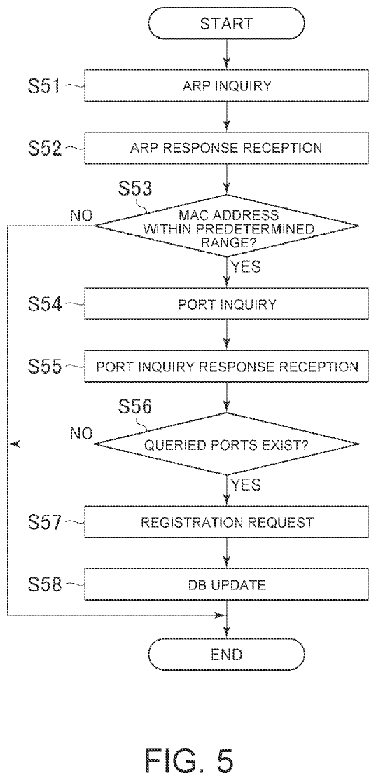

FIG. 5 is a flowchart showing registration control to the data processing system 10 performed by the NW management unit 37 of the additional device 16. Note that this registration control is mainly performed by the connection confirmation unit 371 and the group management unit 372 of the NW management unit 37, and the devices constituting the data processing system 10 are recorded in the group database 373 and managed.

In a step S51, when the additional device 16 is connected to a network and participates in the data processing system 10, the connection confirmation unit 371 autonomously broadcasts an address resolution protocol (ARP) signal to all of the devices constituting the data processing system 10. Here, the ARP signal is generally referred to as an address resolution protocol, and the NW interface drivers 34 of the first device 11 to the third device 13 that receive the signal respond to the originator with ARP responses indicating their own IP addresses and MAC addresses.

In a step S52, the connection confirmation unit 371 receives the ARP responses from the first device 11 to the third device 13. As a result, the connection confirmation unit 371 acquires the IP address and the MAC address used in the other devices that constitute the data processing system 10.

In a step S53, the connection confirmation unit 371 determines whether all the MAC addresses included in the acquired ARP signals are within a predetermined range. Here, the first device 11 to the third device 13 and the additional device 16, which constitute the data processing system 10, are manufactured by the same vendor, and therefore, the range of the MAC addresses possessed by these devices is stored in advance. Therefore, when the MAC addresses of the devices constituting the data processing system 10 are within a predetermined range, the connection confirmation unit 371 determines that there is a constituent member of the data processing system 10 in which the additional device 16 is newly registered.

If the MAC addresses included in the received ARP signals are within a predetermined range (S53: Yes), the processing of a step S54 is performed in order to continue the participation of the additional device 16 to the data processing system 10. If the MAC addresses are not within a predetermined range (S53: No), it is determined that there is no data processing system 10 to which the additional device 16 can participate, and the processing ends.

In the step S54, the connection confirmation unit 371 performs inquiry of the port to be used on the first device 11 to the third device 13 whose MAC addresses are within a predetermined range. Common applications (the pod 45) are used in the data processing system 10, and port numbers used by these applications are predetermined. Therefore, the connection confirmation unit 371 performs inquiry of whether the port numbers are used. The NW interface driver 34 manages the port numbers in use, and thus responds whether the queried port numbers are used.

In a step S55, the connection confirmation unit 371 receives a response indicating whether predetermined port numbers from the NW interface drivers 34 of the first device 11 to the third device 13 that are queried are used.

In a step S56, the connection confirmation unit 371 can determine whether the common pod 45 is operating in the data processing system 10 constituted by the first device 11 to the third device 13 by determining whether a response indicating that particular port numbers are in use is received.

If a response indicating that the predetermined port numbers are in use is received (S56: Yes), it is determined that the connected data processing system 10 is a network system to participate in, and then processing of a step S57 is performed in order to register the additional device 16 in the data processing system 10. If no response indicating that the predetermined port numbers are in use is received (S56: No), it is determined that there is no data processing system 10 to which the additional device 16 can participate, and the processing ends.

In the step S57, in order to newly register the additional device 16 for participation in the data processing system 10, the group management unit 372 sends a request of registering in the data processing system 10 to the group management units 372 of the other devices (for example, the first device 11) in the data processing system 10.

Note that when the group management unit 372 of the other device that receives the registration request determines that a group registration request received from the additional device 16 is in a predetermined format, the additional device 16 is added to the group database 373 and an update of the group database 373 of the other devices including the additional device 16 is instructed.

In a step S58, the group database 373 of the additional device 16 synchronizes and cooperates with the group databases 373 of the other devices of the participated data processing system 10 to acquire information of the addition of the additional device 16 and record the information in the group database 373.

In this way, registration control of the additional device 16 to the data processing system 10 is ended.

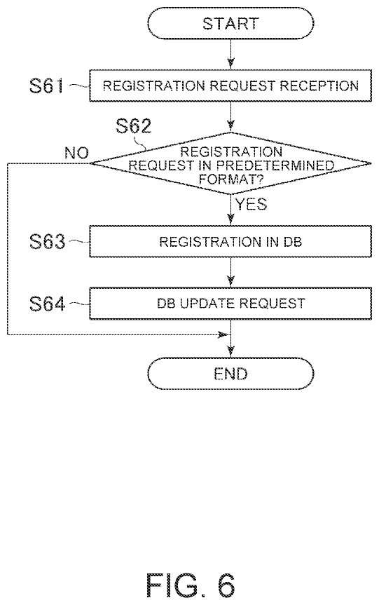

FIG. 6 is a flowchart showing registration control in the other devices (for example, the first device 11) that constitute the data processing system 10 when the additional device 16 participates in the data processing system 10.

In a step S61, the group management unit 372 of the first device 11 receives a request of registering in the data processing system 10 from the group management unit 372 of the additional device 16. Note that the sending of the registration request from the additional device 16 corresponds to the processing of the step S57 in FIG. 5.

In a step S62, the group management unit 372 determines whether the registration request received from the additional device 16 is in a predetermined format. Here, since the devices constituting the data processing system 10 perform predetermined processing, a format of data exchanged between the devices, such as the registration request, is predetermined. Therefore, by determining whether the registration request is in a predetermined format, it is possible to determine whether the device that sends the registration request is a device capable of constituting the data processing system 10.

If the received registration request is in a predetermined format (S62: Yes), the group management unit 372 then performs processing of a step S63 in order to continue the registration processing of the additional device 16. If the received registration request is not in a predetermined format (S62: No), the group management unit 372 determines that the device that sends the registration request cannot constitute the data processing system 10, and ends the control.

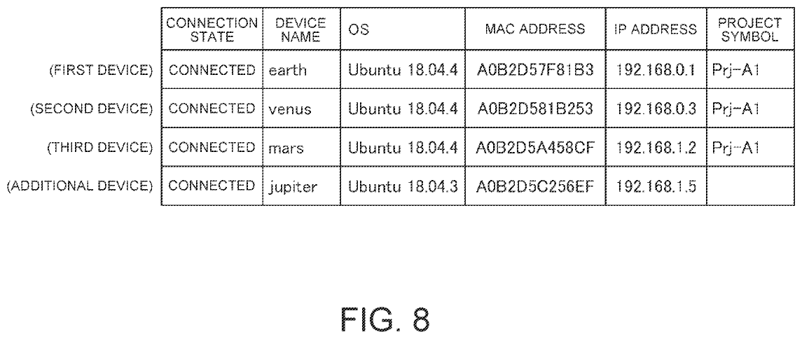

In the step S63, the group management unit 372 registers information of the additional device 16 that sends the registration request in the group database 373 provided in the NW management unit 37. Note that information conforming to a format of the group database 373 shown in FIG. 8 is stored in the registration request, for example.

In a step S64, the group management unit 372 of the first device 11 requests the group management units 372 of the other devices to update the group databases 373. The group database 373 of each device can be updated by synchronizing differences efficiently with each other through a distributed storage type database system such as etcd, diffusion protocol communication, and the like. Note that by synchronizing and updating the differences in this way, the latest information is recorded in the group database 373 of the additional device 16.

In this way, registration control of the additional device 16 to the data processing system 10 is ended.

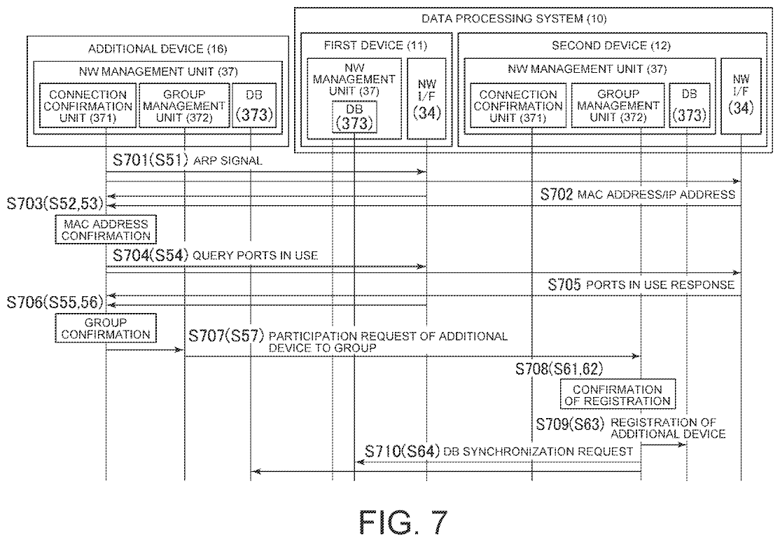

FIG. 7 is a sequence chart showing mutual processing between devices when the additional device 16 makes a registration request to the data processing system 10. Note that the processing steps shown in FIGS. 5 and 6 are shown in parentheses corresponding to steps S701 to S710 shown in this drawing.

In a step S701, when the connection to the LAN 14 is completed and the IP address is set, the additional device 16 (connection confirmation unit 371) selects a random device (the first device 11 to the third device 13) constituting the data processing system 10 connected to the LAN 14 and autonomously sends an ARP signal to the selected device. The device that receives the ARP signal responds with its IP address and Ethernet MAC address to the sending device. Note that the NW interface driver 34 performs the response processing to the ARP signal.

In the step S702, when the ARP signal arrives at the first device 11 to the third device 13 constituting the data processing system 10, the NW interface driver 34 responds with the IP address and the MAC address to the additional device 16 (connection confirmation unit 371).

In the step S703, when receiving the ARP signal from the first device 11 to the third device 13, the additional device 16 (connection confirmation unit 371) determines whether the received MAC address is within a predetermined range. The additional device 16 can determine whether there is a member device of the data processing system 10 by determining whether the MAC address is in a range allocated by the same vendor.

For example, the LAN 14 may be connected to other devices in addition to the first device 11 to the third device 13. However, these devices are not devices that can construct the data processing system 10, and therefore do not have MAC addresses in a predetermined range. Therefore, when not all the MAC addresses included in the received ARP signal are within a predetermined range, the additional device 16 (connection confirmation unit 371) determines that there is no device constituting the data processing system 10 to participate, and then ends the processing.

On the other hand, when the MAC address included in the received ARP signal is within a predetermined range, the additional device 16 (connection confirmation unit 371) determines that there is a member device that constitutes the data processing system 10, and performs processing of the step S704 to continue the processing of registering the device 16 in the data processing system 10.

In the step S704, the additional device 16 (connection confirmation unit 371) queries the first device 11 to the third device 13 whose MAC addresses are within a predetermined range about a list of ports in use. The inquiry is made by general-purpose TCP/IP defined processing (for example, netstat command). Note that instead of the inquiry about the list of ports in use, it is also possible to query about whether predetermined ports are used.

In the step S705, the NW interface drivers 34 of the first device 11 to the third device 13 respond to the additional device 16 with the ports in use.

In the step S706, the additional device 16 (connection confirmation unit 371) determines whether there are member devices in which the common pod 45 operates in the data processing system 10 by determining whether specific port numbers are in use according to the response content.

When the use of predetermined ports cannot be confirmed, the additional device 16 (connection confirmation unit 371) determines that the data processing system 10 is not a network system to participate in, and ends the registration processing to the group. On the other hand, when the use of predetermined port numbers can be confirmed, the connection confirmation unit 371 in the additional device 16 determines the devices using those port numbers as the member devices. Then, the connection confirmation unit 371 instructs the group management unit 372 of its own to send a registration request to the data processing system 10.

In the step S707, the group management unit 372 sends the registration request to any device (second device 12) constituting the data processing system 10. Note that the registration request may be sent to the first device 11 or the third device 13.

In the step S708, the group management unit 372 of the second device 12 determines whether the received registration request is in a predetermined format. If it is in a predetermined format, the additional device 16 is a device that can be registered in the data processing system 10, so that the group management unit 372 determines that registration in the group is possible.

In the step S709, the group management unit 372 newly records information of the additional device 16 in the group database 373 when the registration request is in a predetermined format.

In the step S710, the group management unit 372 requests the other devices (the first device 11 and the third device 13) in the NW management unit 37 and the group database 373 provided in the additional device 16 to reflect the data indicating that the additional device 16 is registered. Note that this synchronization is performed by the group management unit 372 of each device synchronizes and cooperates with each other.

In this way, by registering the additional device 16 in the group database 373, the additional device 16 is newly added to the data processing system 10 and cooperates and operates with the other devices (the first device 11 to the third device 13).

FIG. 8 is an example of a database stored in the group database 373.

In the group database 373 of this example, the leftmost column shows the first device 11 to the third device 13 and the additional device 16 as reference information indicating a correspondence relation with the devices shown in the present embodiment, but this information may not be included. Furthermore, heading to the right side, columns of “connection state”, “device name”, “OS version”, “MAC address”, “IP address”, and “project symbol” are provided.

The “connection state” column shows a state indicating whether each device is connected to the data processing system 10. The connection state of each device to the data processing system 10 (LAN 14) can be known by periodically sending an ARP signal from the connection confirmation unit 371 of any device. If there is a device that is temporarily removed, the device cannot respond to the ARP signal and thus is in a disconnected state.

The “device name” column shows a name registered by the user for each device. An OS version of each device is recorded in the “OS version” column. When the information is recorded in the group database 373 of each device, the information is also recorded in the group databases 373 of the other devices by synchronization processing.

Network information is recorded in the “MAC address” and “IP address” columns. The network information may be network information of the other devices acquired by any device using an ARP signal, or may be self-information recorded by each device. The recorded information is also recorded in the group database 373 of the other devices by synchronization processing. Note that the information mainly corresponds to information required for the communication function in the network layer provided by the IP processing unit 35.

A “project symbol” indicates a project that operates on each device. In this example, the projects of the first device 11 to the third device 13 are all the same, and the project of the additional device 16 is not set. By using such symbols, it is possible to classify and set the devices for each processing function.

With such a group database 373, the devices constituting the data processing system 10 can be managed.

FIG. 9 shows the initial setting control after the participation of the additional device 16 to the data processing system 10. Configurations of an NW application processing unit 38 to a general-purpose database 46 are downloaded from the other devices constituting the data processing system 10 by the initial setting control. The other devices from which software is downloaded are not limited to the first device 11 to the third device 13, and may be the storage 15.

In a step S901, a boot area reservation processing unit 374 of an NW management unit 37 of the additional device 16 requests acquisition of images of the resource acquisition units 381 of the NW application processing units 38 of the other devices.

In a step S902, the additional device 16 acquires the images of the resource acquisition units 381 from the other devices. Then, in a step S903, a resource acquisition unit 381 is formed using the acquired images.

In a step S904, the resource acquisition unit 381 requests images of the NW application units 382 of the other devices. When the images of the NW application units 382 are acquired in a step S905, an NW application unit 382 is formed using the acquired images in a step S906. In this way, operation resource of the NW application processing unit 38 is acquired.

In a step S907, the resource acquisition unit 381 further requests images of the resource acquisition units 391 of the orchestration tools 39 of the other devices. In a step S908, when the images of the resource acquisition units 391 are acquired, a resource acquisition unit 391 is formed using the acquired images in a step S909.

In a step S910, the resource acquisition unit 391 requests images of the orchestration units 392 of the other devices. When the images of the orchestration units 392 are acquired in a step S911, an orchestration unit 392 is formed using the acquired images in a step S912. In this way, operation resource of the orchestration tool 39 is acquired.

Although not shown in FIG. 9, at the same time with or prior to the orchestration unit 392, a container engine 40 is provided using images acquired from the other devices. An orchestration processing area 41 can be formed by the orchestration tool 39 and the container engine 40 configured in this way.

In a step S913, the orchestration unit 392 forms the orchestration processing area 41 serving as an execution environment of the container 44 and instructs formation of a master 42 that performs management in the orchestration processing area 41. In a step S914, the master 42 is provided in response to the instruction. In a step S915, if the master 42 requests acquisition of the pod 45 of the other devices, in a step S916, an image of the pod 45 is acquired, and in a step S917, the pod 45 is deployed. Although not shown, the general-purpose database 46 is also downloaded from the other devices.

In this way, the configurations of the NW application processing unit 38 to the general-purpose database 46 are sequentially downloaded from the other devices of the data processing system 10 from the state in which only the NW management unit 37 is constituted in the additional device 16. Note that these images may be stored in any one of the first device 11, second device 12, third device 13, and storage 15, and these images may also be deployed to the additional device 16 from a plurality of sources.

According to the first embodiment, the following effects can be obtained.

The additional device 16, which is the information processing device of the first embodiment, is a member device that constitutes the data processing system 10 (network system). The additional device 16 includes the connection confirmation unit 371 (detection unit) and the group management unit 372 (list management unit). When connected to the LAN 14, the connection confirmation unit 371 performs autonomous inquiry to the data processing system 10 and detects other member devices (first device 11 to third device 13) that together form the data processing system 10. The group management unit 372 updates the group database 373 (list) indicating the member devices of the data processing system 10 that are newly registered in the data processing system 10 via the detected other member devices.

With this configuration, the other member devices (first device 11 to third device 13) that can form the data processing system 10 are specified by autonomous inquiry after being connected to the data processing system 10. Then, the additional device 16 is registered as a new member device in the group database 373 indicating the member devices constituting the data processing system 10. In this way, there is no need for a host for managing the data processing system 10, which is a network system, and the data processing system 10 can be constructed without considering master-slave relations, connection orders, and the like among devices.

According to the additional device 16, which is the information processing device of the first embodiment, communication performed between the connection confirmation unit 371 (detection unit) and the other member devices by the group management unit 372 (list management unit) is performed in the Internet layer. With such a configuration, even in a state where the additional device 16 is not installed with software that provides a communication function by a transport layer or the like in a higher level than the network layer, it is possible to autonomously communicate with the other member devices and register in the data processing system 10, so that the data processing system 10 can be constructed more flexibly.

According to the additional device 16, which is the information processing device of the first embodiment, the group database 373 stores the IP addresses and the MAC addresses necessary for the communication by the network layer within the data processing system 10. With such a configuration, the additional device 16 can be registered in the data processing system 10 with minimum configurations as long as minimum communication functions can be implemented for the registration control of the member device.

According to the information processing device of the first embodiment, for example, the group management unit 372 of the additional device 16 synchronizes with the group management units 372 of the other member devices (first device 11 to third device 13) to update the group database 373.

With such a configuration, when a change occurs in the group database 373 in one device, synchronization is automatically performed, and the group databases 373 in the other devices can be updated. As a result, it is possible to manage the group databases 373 with the same content in all the devices participating in the data processing system 10, so that the data processing system 10 can be constructed without considering the master-slave relations, connection orders, and the like among the devices.

According to the information processing device of the first embodiment, the group management unit 372 of the additional device 16 synchronizes with the group management units 372 of the other member devices (first device 11 to third device 13) using the diffusion protocol (such as the gossip overlay protocol). By using the diffusion protocol, the change in the group database 373 in one device can be quickly reflected in the group databases 373 of the other devices. As a result, it is possible to manage the group databases 373 with the same content in all the devices participating in the data processing system 10, so that the data processing system 10 can be reliably managed using the group databases 373.

According to the information processing device of the first embodiment, the group management unit 372 constructs the group database 373 using a distributed storage type database system (such as the etcd). The distributed storage type database system can reliably reflect the change in the group database 373 of one device to the group databases 373 of the other devices, so that the data processing system 10 can be reliably managed using the group databases 373.

According to the information processing device of the first embodiment, the connection confirmation unit 371 (detection unit) detects a device whose response to inquiry satisfies a predetermined condition as another member device constituting the data processing system 10 (S53, S56). By including such determination processing, it is possible to exclude network devices that are devices connected to the LAN 14 and do not constitute the data processing system 10. As a result, it is possible to reduce a risk of sending a request of registering in the data processing system 10 to a wrong device.

According to the information processing device of the first embodiment, the connection confirmation unit 371 (detection unit) makes an inquiry using an ARP signal (S51), and detects a device whose MAC address included in the response is within a predetermined range as another member device constituting the data processing system 10 (S53). Since the NW interface driver 34 autonomously responds to the ARP signal, a response burden on the device that receives the inquiry is small. In this way, it is possible to reduce a risk of sending a request of registering in the data processing system 10 to a wrong device with less burden.

According to the information processing device of the first embodiment, the connection confirmation unit 371 (detection unit) queries whether predetermined ports are in use (S54), and detects devices using the predetermined ports as the other member devices constituting the data processing system 10 (S56). Since the NW interface driver 34 autonomously responds to the port inquiry, a response burden on the device that receives the inquiry is small. It is not necessary to store a predetermined range in advance as the MAC addresses, and it is only necessary to specify the port number of the application that operates on the device itself, so that convenience is high. As a result, it is possible to reduce a risk of sending a request of registering in the data processing system 10 to a wrong device with less configurations and burden.

According to the information processing device of the first embodiment, the group management unit 372 (list management unit) sends a participation request to the other member devices detected by the connection confirmation unit 371 (detection unit) (S57), and when it is determined that the participation request satisfies a predetermined criterion (S62), the additional device 16 is newly registered in the data processing system 10 (S63). In this way, in the member device that accepts the participation request, by determining whether the additional device 16 that sends the participation request satisfies a criterion, it is possible to reduce a risk of erroneously accepting the request of registering in the data processing system 10.

According to the information processing device of the first embodiment, when the registration request conforms to a predetermined format, it is determined that the criterion is satisfied (S62), and the additional device 16 is newly registered in the data processing system 10 (S63). In this way, by performing a simple determination of format confirmation, it is possible to reduce a risk of erroneously accepting the request of registering in the data processing system 10.

The information processing device of the first embodiment further includes the boot area reservation processing unit 374 (initial setting unit). After the registration of the additional device 16 in the data processing system 10 is completed, the boot area reservation processing unit 374 operates autonomously to construct the software configuration in the additional device 16. With such a configuration, the additional device 16 can be shipped with a simple configuration including only minimum software configurations. Since the additional device 16 has the latest software configuration during the initial setting, it is possible to improve functionality and robustness thereof.

According to the information processing device of the first embodiment, the boot area reservation processing unit 374 constructs software configurations using image data acquired from other processing devices constructing the data processing system 10. In this way, by acquiring the image data from the other member devices constituting the data processing system 10 arranged in the local environment connected to the LAN 14 instead of the WAN 17, constitution of an image distribution server on a cloud becomes unnecessary, and therefore, autonomous operation can be performed only by the data processing system 10 in the local environment.

According to the information processing device of the first embodiment, the software of the additional device 16 is provided with subsections divided into a plurality of layers such as a layer of the NW application processing unit 38, a layer of the orchestration tool 39, and a layer of a containerized application that operates in the orchestration processing area 41 in a higher level. Then, as shown in FIG. 9, the images are acquired and software is installed for each of these subsections. With such a configuration, images can be acquired from different member devices for each of the plurality of subsections, so that initial setting processing can be distributed and stably performed.

According to the information processing device of the first embodiment, since the orchestration tool 39 and the container engine 40 are provided, an application that performs predetermined processing is containerized, and hardware resource for operating the containerized processing unit is managed by the orchestration tool 39. By containerizing each processing unit, a processing speed of the member devices constituting the data processing system 10 can be increased, so that data processing can be performed without delay.

### Second Embodiment

In the group database 373 of the first embodiment, the information related to the devices constituting the data processing system 10 is shown, but the present invention is not limited thereto. In the second embodiment, an example that further includes information related to the pods 45 operating in the devices that constitute the data processing system 10 will be described.

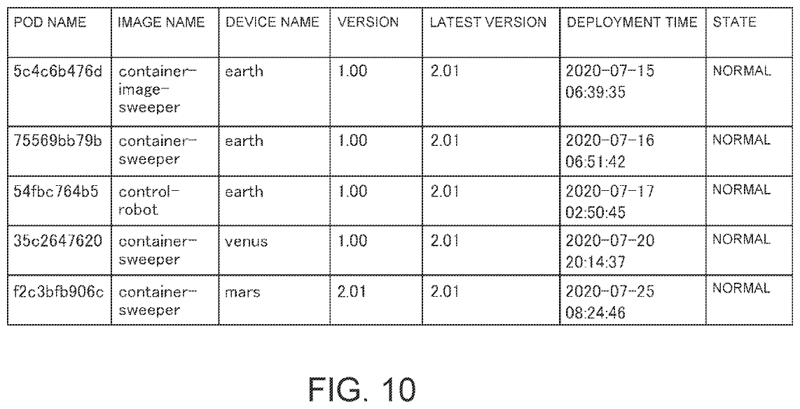

FIG. 10 shows an example of the group database 373 in the second embodiment. Note that the group database 373 may store items shown in a table of FIG. 10 in addition to the items shown in the table of the first embodiment of FIG. 8. As an example, when the items of both tables coexist, the items may be stored associated with values.

The group database 373 shows a “pod name”, an “image name”, a “device name”, a “version”, a “latest version”, a “deployment time”, and a “state”. Note that in this example, a part of the information of the pods 45 operating in the first device 11 (earth), the second device 12 (venus), and the third device 13 (mars) is shown.

The group management unit 372 of the NW management unit 37 accesses the container deployment system 421 of the master 42, acquires all the information of the pods 45 operating in the device, and records the information in the group database 373. The recorded information is also recorded in the group databases 373 of the other devices by synchronization processing, so that the devices constituting the data processing system 10 can mutually understand the pods 45 in the other devices.

The names of the pods 45 are recorded in the “pod name”, and the names of execution objects of the pods 45 are recorded in the “image name”. Note that the pod 45 is deployed using a predetermined image, and the name of the pod 45 may be, for example, a random number such as a hash value. In this way, since the name of the pod 45 differs from the name of the image of the corresponding execution object, it is easy to specify a directory to deploy from by recording the image name when deploying a predetermined pod 45 from the other devices.

The “device name” indicates the device on which the pod operates in this example. The “version” stores a version of the pod 45, and the “latest version” stores the latest version of the pod 45 that can be detected in the data processing system 10. If the “version” and the “latest version” do not match with each other, it can be determined that the version needs to be upgraded.

The “deployment time” indicates a time when the pod 45 is deployed. When this time has passed a certain period of time (for example, several days) from the current time, the pod 45 may be restarted in order to improve stability of processing. The “state” indicates whether the pod 45 operates normally.

By recording the information of the pod 45 in the group database 373 in this way, it becomes possible to specify the request destination of the image of the pod 45 in the step S915 of FIG. 9. As a result, the access to the devices that do not include the pod 45 is reduced, so that the speed of processing can be increased.

According to the second embodiment, the following effects can be obtained.

According to the information processing device of the second embodiment, the group database 373 can record the pod 45 (applications) installed in the member device that constitutes the data processing system 10. Then, the resource acquisition unit 391 refers to the group database 373, acquires an image from the member device including the desired application (S915), and deploys (installs) the pod 45 using the image.

By configuring in this way, when initially setting the additional device 16, an image is requested from the other devices in which the necessary pods 45 operate. As a result, there is no need to request images from the other devices that do not include the desired pod 45, so that the initial setting time can be shortened.

### Third Embodiment

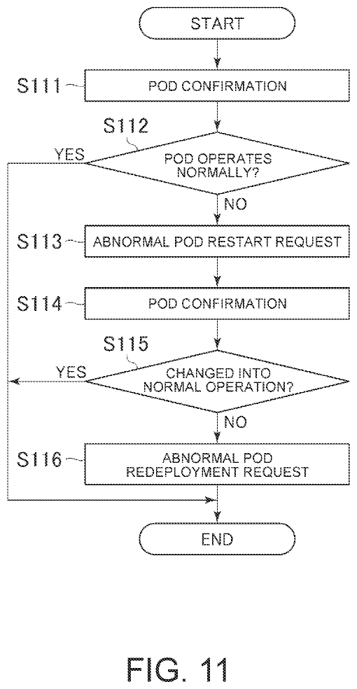

In the third embodiment, when the information of the pod 45 is recorded in the group database 373 as shown in FIG. 10, an example of control using the state of the pod 45 indicated in the group database 373 will be described with reference to FIGS. 11 to 13.

FIGS. 11 to 13 show an example of processing when the pod 45 that does not operate normally is found by referring to the “state” of the group database 373. In this example, the pod 45 of the second device 12 does not operate normally, and the first device 11 attempts to restart the pod 45 that does not operate normally of the second device 12. Then, since the restart does not change the operation to a normal state, the pod 45 is redeployed by reacquiring the image.

FIG. 11 is a flowchart showing redeployment request control in the first device 11.

In a step S111, the group management unit 372 accesses the group database 373 and refers to the “state” of the pod 45. Then, in a step S112, the group management unit 372 determines whether all the pods 45 operate normally.

If all the pods 45 operate normally (S112: Yes), there is no pod 45 that needs to be restarted, so that the restart control ends. If not all the pods 45 operate normally and there is a pod (abnormal pod) 45 that does not operate normally (S112: No), then the processing of a step S113 is performed. In the following example, the second device 12 includes the pod 45 that does not operate normally.

In the step S113, the group management unit 372 of the first device 11 requests restarting the pod 45 in the abnormal state of the second device 12. Thereafter, in a step S114, the group management unit 372 of the first device 11 accesses the group database 373 again and refers to the “state” of the pod 45. Then, in a step S115, the group management unit 372 determines whether the pod 45 that does not operate normally is changed to operating normally.

If the state of the pod 45 is changed to normal operation (S115: Yes), the control ends. If the operating state of the pod 45 does not become normal (S115: No), then the processing of a step S116 is performed.

In the step S113, the group management unit 372 of the first device 11 requests redeployment of the pod 45 of the second device 12. In the second device 12, the redeployment of the pod 45 that does not operate normally is performed. In this way, the pod 45 that does not operate normally in the second device 12 can be changed to operating normally.

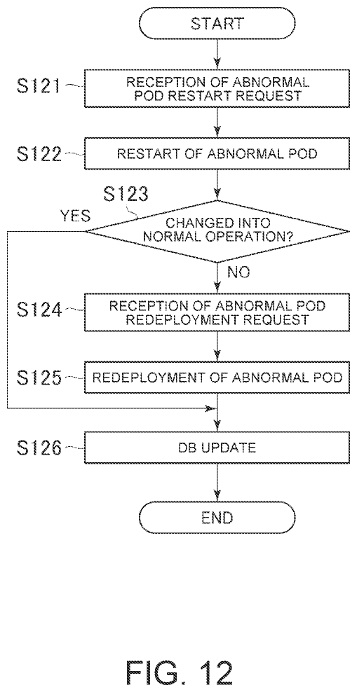

FIG. 12 is a flowchart showing redeployment control in the second device 12.

In a step S121, the group management unit 372 of the second device 12 receives a request of restarting the pod 45 that does not operate normally from the group management unit 372 of the first device 11. Then, in a step S122, the group management unit 372 requests the master 42 to restart the pod 45 that does not operate normally.

In a step S123, if the master 42 successfully restarts the pod 45 and the operating state becomes normal (S123: Yes), the control ends. If the operating state of the pod 45 does not become normal (S123: No), then the processing of a step S124 is performed. Note that confirmation of this operating state is performed by querying the master 42.

In a step S124, the group management unit 372 of the second device 12 receives a request of redeploying the pod 45 that does not operate normally from the group management unit 372 of the first device 11. Then, in a step S125, the group management unit 372 instructs the master 42 to redeploy the pod 45 that does not operate normally. In response to the instruction, the master 42 acquires the image of the pod 45 that does not operate normally from the other devices and redeploys the pod 45.

Here, since the group database 373 stores the states of all the pods 45 of all terminals, the image name of the pod 45 to be redeployed is referred to, and the image is acquired from the other devices storing the image. For example, when the second terminal (venus) “35c2647620” does not operate normally, since the image name of the pod thereof is “container-sweeper”, the image can be obtained from the third device 13 (mars) in which a pod 45 with the same image name operates.

After completing the series of processing, in a step S126, the group management unit 372 of the second device 12 records in the group database 373 that the operating state of the pod 45 is changed to be normal. The group database 373 of each device synchronizes with the group database 373 of the second device 12 to record that the state of the pod 45 is changed to normal operation.

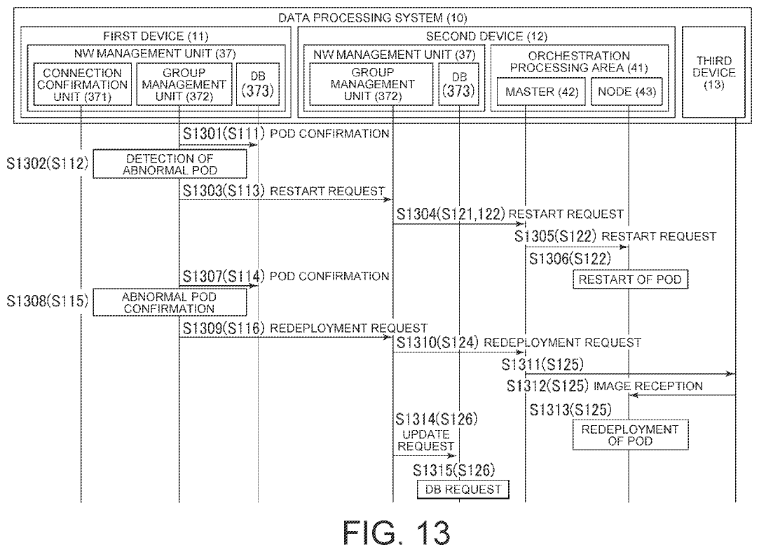

FIG. 13 is a flowchart showing mutual processing between two devices when the group management unit 372 of the first device 11 performs redeployment request control and the second device 12 performs redeployment control of the pod 45. Note that the processing steps shown in FIGS. 11 and 12 are shown in parentheses corresponding to steps S1301 to S1314 shown in this drawing.

In the step S1301, the group management unit 372 accesses the group database 373 and confirms the operating state of each pod 45. Then, in the step S1302, the group management unit 372 determines whether all the pods 45 operate normally. In this example, the pod 45 that does not operate normally (abnormal pod) is detected.

In the step S1303, the group management unit 372 of the first device 11 requests the group management unit 372 of the second device 12 to restart the pod 45 that does not operate normally. In the step S1304, the group management unit 372 of the second device 12 requests the master 42 to restart the pod 45. In the step S1306, the pod 45 is restarted. Note that in this embodiment, the pod 45 cannot be restarted, or the pod 45 does not operate normally even after the restart.

In the step S1307, the group management unit 372 of the first device 11 accesses the group database 373. Then, in the step S1308, it is determined whether the pod 45 that does not operate normally is changed to operating normally. Then, in the step S1308, if the group management unit 372 confirms that the operating state of the pod 45 is not normal, then in the step S1309, the group management unit 372 of the first device 11 requests the second device 12 to redeploy the pod 45.

In the step S1310, when receiving the redeployment request from the group management unit 372 of the first device 11, the group management unit 372 of the second device 12 requests the master 42 to redeploy the pod 45 that does not operate normally. Then, in the step S1311, the master 42 requests the image of the pod 45 to be redeployed from the other device. Then, in the step S1312, the master 42 acquires the image of the pod 45, and redeploys the pod 45 in the node 43 in the step S1313.

Here, it is necessary that the device from which the image of the pod 45 is acquired in the step S1311 stores the image. Therefore, in the step S1310, the group management unit 372 refers to the group database 373 to specify the device (the third device 13) storing the image of the pod 45 to be redeployed, and instructs the master 42 to acquire the image from the third device 13.

In the step S1314, the group management unit 372 of the second device 12 records in the group database 373 that the operating state of the pod 45 is changed to be normal. Thereafter, in the step S1315, by synchronizing with the group database 373 of the second device 12, the group database 373 of each device records that the operating state of the pod 45 is changed to be normal.

According to the third embodiment, the following effects can be obtained.

According to the information processing device of the third embodiment, the group database 373 can further record the operating state of the pod 45 (applications) installed in the member device that constitutes the data processing system 10. When the group management unit 372 of one device detects abnormal operation of the pod 45 in the other device, the group management unit 372 requests restarting the pod 45 (S113) or redeploying the pod 45 (S115).

With such a configuration, the member devices that constitute the data processing system 10 can mutually detect abnormal operation of the pods 45, and furthermore, the pods 45 can be repaired by restarting or redeploying, so that the data processing system 10 and the member devices thereof can be improved in maintainability and robustness.

Although the embodiments of the present invention have been described above, the above embodiments merely exemplify some of application examples of the present invention and do not intend to limit the technical scope of the present invention to the specific configurations of the above embodiments.

The present application claims priority under Japanese Patent Application No. 2020-137631 filed to the Japan Patent Office on Aug. 17, 2020, and an entire content of this application is incorporated herein by reference.

1. An information processing device, in which a containerized application is operated by an orchestration tool, serving as a member device that constitutes a network system comprising:
a detection unit that performs autonomous inquiry to the connected network system and detects another member device that together forms the network system;
a list management unit that, when the another member device is detected by the detection unit, updates a list indicating member devices of the network system that are newly registered in the network system via the another member device; and
an initial setting unit that constructs a software configuration within the information processing device after the information processing device is newly registered in the network system, wherein
the list includes information of software installed on each member device, and
the initial setting unit constructs the software configuration based on the information of the software included in the list.

2. The information processing device according to claim 1, wherein
the initial setting unit constructs the software configuration by an image data obtained from the another member device.

3. The information processing device according to claim 1, wherein
the detection unit and the list management unit communicate with the another member device in a network layer.

4. The information processing device according to claim 3, wherein
information used for communication by the network layer performed in the network system is recorded in the list.

5. The information processing device according to claim 1, wherein
the list management unit updates the list in synchronization with the list management units of the another member device.

6. The information processing device according to claim 1, wherein
the list manager uses a diffusion protocol to synchronize with the list management unit of the another member device.

7. The information processing device according to claim 1, wherein
the list management unit constructs the list using a distributed storage type database system.

8. The information processing device according to claim 1, wherein
the detection unit detects a device whose response to the inquiry satisfies a predetermined condition as the another member device.

9. The information processing device according to claim 8, wherein
the detection unit performs the inquiry using an ARP signal, and detects a device having a MAC address included in a response to the ARP signal within a predetermined range as the another member device.

10. The information processing device according to claim 8, wherein
the detection unit performs inquiry of whether a predetermined port number is used, and detects a device using the predetermined port number as the another member device.

11. The information processing device according to claim 1, wherein
the list management unit sends a participation request to the another member device detected by the detection unit, and if the another member device determines that the participation request satisfies a predetermined criterion, the information processing device is newly registered in the network system via the another member device.

12. The information processing device according to claim 11, wherein
when the participation request is in a predetermined format, the another member device determines that the participation request satisfies the predetermined criterion.

13. The information processing device according to claim 1, wherein
the initial setting unit constructs the software configuration using image data acquired from another processing device constructing the network system.

14. The information processing device according to claim 1, wherein
the software configuration is constituted by a plurality of subsections, and
the initial setting unit constitutes a resource acquisition unit for each subsection, and causes the resource acquisition unit to constitute the subsection.

15. The information processing device according to claim 1, wherein
the resource acquisition unit acquires an image from the member device including a desired application and installs the application based on the list.

16. The information processing device according to claim 15, wherein
the list further records an operating state of the application installed on the member device, and
when the application is determined to be operating abnormally based on the list, an image is obtained from the another member device including the application and the application is reinstalled on the member device.

17. The information processing device according to claim 15, wherein
the application is containerized, and hardware resource for operating the containerized processing unit is managed by the orchestration tool.

18. A method for controlling an information processing device, in which a containerized application is operated by an orchestration tool, serving as a member device that constitutes a network system, comprising:
a step of performing autonomous inquiry to the connected network system and detecting another member device that together forms the network system;
a step of, when the another member device is detected, updating a list indicating member devices of the network system that are newly registered in the network system via the another member device; and
a step of initial setting by constructing a software configuration within the information processing device after the information processing device is newly registered in the network system, wherein
the list includes information of software installed on each member device, and
in the step of the initial setting, the software configuration is constructed based on the information of the software included in the list.

19. (canceled)

20. A recording medium storing a computer program used for controlling an information processing device serving, in which a containerized application is operated by an orchestration tool, as a member device that constitutes a network system, wherein
the computer program
performs autonomous inquiry to the connected network system and detects another member device that together forms the network system,
when the another member device is detected, updates a list indicating member devices of the network system that are newly registered in the network system via the another member device, and
perform an initial setting by constructing a software configuration within the information processing device after the information processing device is newly registered in the network system, wherein
the list includes information of software installed on each member device, and
the initial setting unit constructs the software configuration based on the information of the software included in the list.
